(19) United States
(12) Patent Application Publication
(10) Pub. No.: US 2024/0094391 A1
(43) Pub. Date: Mar. 21, 2024

(54) DEVICE, METHOD, AND PROGRAM FOR DETECTING ABNORMAL POSITION

(71) Applicant: NEC Corporation, Tokyo (JP)

(72) Inventor: Jiro Abe, Tokyo (JP)

(73) Assignee: NEC Corporation, Tokyo (JP)

(21) Appl. No.: 18/205,418

(22) Filed: Jun. 2, 2023

(30) Foreign Application Priority Data
Sep. 15, 2022 (JP) 2022-147305

(51) Int. Cl. G01S 17/89; G01S 7/48; G01S 7/4911; G01S 7/4914; G01S 17/08

(52) U.S. Cl. CPC G01S 17/89; G01S 7/4808; G01S 7/4911; G01S 7/4914; G01S 17/08

(57) ABSTRACT

Provided is a technique that specifies (a) a part actually having an abnormal change in surface or (b) a region including the part. The device includes at least one processor configured to: extract, on the basis of a reflection signal generated in response to a signal that one of a plurality of emitting sections included in a distance measuring device has emitted to a subject, a part of a surface of the subject which part has an abnormal change, the extracting being carried out for each of the plurality of emitting sections; and specify a region of the surface, the region including parts of the surface which parts have been extracted in relation to two or more of the plurality of emitting sections.

This Nonprovisional application claims priority under U.S.C. § 119 on Patent Application No. 2022-147305 filed in Japan on Sep. 15, 2022, the entire contents of which are hereby incorporated by reference.

### TECHNICAL FIELD

The present invention relates to a device, a method, and a program each of which detects an abnormal position.

### BACKGROUND ART

There has been known a technique for determining the presence or absence of an abnormality in a surface of a structure with use of point cloud data indicating the surface of the structure. For example, Patent Literature 1 discloses a display data generating device including: a facility data generating section that generates three-dimensional point cloud data indicating a surface of a facility; and a thermal image data obtaining section that obtains thermal image data of the facility. Patent Literature 1 states that this device can display an internal deformation state of the facility.

Patent Literature 2 discloses a refinement system that obtains a point cloud and an ambient image with use of a Light Detection And Ranging (LiDAR) sensor and generates enhanced data according to an enhancer pipeline including a set of processing routines in processing the point cloud and the ambient image.

### CITATION LIST

### Patent Literature

[Patent Literature 1]
International Publication No. WO 2019/111391
[Patent Literature 2]
Specification of Japanese Patent Application Publication, Tokukai, No. 2022-51524

### SUMMARY OF INVENTION

### Technical Problem

The display data generating device disclosed in Patent Literature 1 can estimate the internal deformation on the basis of a temperature change of the wall surface. However, this display data generating device requires not only a laser scanner device but also a thermography device, which is an additional device for obtaining the thermal image data. Meanwhile, Patent Literature 2 states that the refinement system disclosed therein is configured to synchronize pieces of output data from a plurality of LiDAR sensors and to correlate pieces of data from similar timeframes to each other. However, it cannot be said that, even by the plural pieces of data correlated to each other, these pieces of data indicate actual occurrence of an abnormal change in the surface (i.e., deformation) with an adequately high possibility, i.e., with an adequately high probability.

An example aspect of the present invention was made in view of the above problems, and has an example object to provide a technique for identifying (a) a part actually having an abnormal change in a surface or (b) a region including the part.

### Solution to Problem

A device in accordance with an example aspect of the present invention includes at least one processor configured to: extract, on a basis of a reflection signal generated in response to a signal that one of a plurality of emitting sections included in a distance measuring device has emitted to a subject, a part of a surface of the subject which part has an abnormal change, the extracting being carried out for each of the plurality of the emitting sections; and specify a region of the surface, the region including parts of the surface which parts have been extracted in relation to two or more of the plurality of emitting sections.

A method in accordance with an example aspect of the present invention includes: at least one processor extracting, on a basis of a reflection signal generated in response to a signal that one of a plurality of emitting sections included in a distance measuring device has emitted to a subject, a part of a surface of the subject which part has an abnormal change, the extracting being carried out for each of the plurality of the emitting sections; and the at least one processor specifying a region of the surface, the region including parts of the surface which parts have been extracted in relation to two or more of the plurality of emitting sections.

A storage medium in accordance with an example aspect of the present invention is a non-transitory, computer-readable storage medium in which a program is stored, the program causing a computer to execute: a process of extracting, on a basis of a reflection signal generated in response to a signal that one of a plurality of emitting sections included in a distance measuring device has emitted to a subject, a part of a surface of the subject which part has an abnormal change, the extracting being carried out for each of the plurality of the emitting sections; and a process of specifying a region of the surface, the region including parts of the surface which parts have been extracted in relation to two or more of the plurality of emitting sections.

### Advantageous Effects of Invention

In accordance with an example aspect of the present invention, it is possible to specify (a) a part of actually having an abnormal change in a surface or (b) a region including the part.

### BRIEF DESCRIPTION OF DRAWINGS

FIG. 1 is a block diagram illustrating a configuration of an abnormal position detecting system 2 in accordance with a first example embodiment of the present invention.

FIG. 2 is a flowchart illustrating a flow of an abnormal position detection method S1 in accordance with the first example embodiment.

FIG. 3 is a block diagram illustrating a configuration of an abnormal position detecting system 2A in accordance with a second example embodiment of the present invention.

FIG. 4 is a block diagram illustrating a configuration of an abnormal position detecting system 2B in accordance with a third example embodiment of the present invention.

FIG. 5 is a view schematically illustrating a method for obtaining a plurality of data sets by three-dimensional Lidar.

FIG. 6 is a view schematically illustrating a method according to which an extracting section extracts a changed part having a change in surface profile.

FIG. 7 is a view schematically illustrating another method according to which the extracting section extracts a changed part having a change in surface profile.

FIG. 8 is a view schematically illustrating a method for specifying a region including a plurality of changed parts arranged relatively densely.

FIG. 9 is a view schematically illustrating a specific example of the method for specifying the dense arrangement region.

FIG. 10 is a view schematically illustrating how a specifying section specifies one of quadrangular regions into which an inner surface of a tunnel is divided.

FIG. 11 is a block diagram illustrating a configuration of an abnormal position detecting system 2B in accordance with a fourth example embodiment of the present invention.

FIG. 12 is a block diagram illustrating a configuration of an abnormal position detecting system 2C in accordance with a fifth example embodiment of the present invention.

FIG. 13 is a view illustrating a configuration for realizing an abnormal position detecting device by software.

### DESCRIPTION OF EMBODIMENTS

### First Example Embodiment

The following description will discuss a first example embodiment of the present invention in detail with reference to the drawings. The present example embodiment is a basic form of example embodiments described later.

(Configuration of Abnormal Position Detecting System 2)

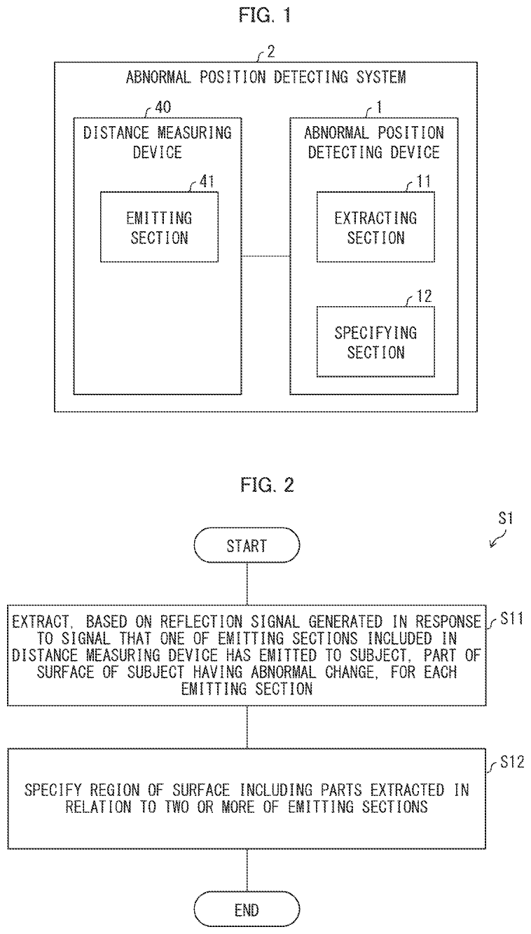

The following will describe, with reference to FIG. 1, a configuration of an abnormal position detecting system 2 in accordance with the present example embodiment. FIG. 1 is a block diagram illustrating a configuration of the abnormal position detecting system 2. The abnormal position detecting system 2 is a device that detects deformation (abnormal change) of a surface of a structure. Determination of whether or not the deformation of the surface is an abnormal change can be made on the basis of comparison with an original surface profile of the structure.

As shown in FIG. 1, the abnormal position detecting system 2 includes an abnormal position detecting device 1 and a distance measuring device 40. The abnormal position detecting device 1 includes an extracting section (extracting means) 11 and a specifying section (specifying means) 12. The abnormal position detecting device 1 obtains surface profile data obtained by the distance measuring device 40.

The distance measuring device 40 includes an emitting section (emitting means) 41 configured to emit a signal. The emitting section 41 includes n emitting sections 41i (i=1 to n, n is an integer of not less than 2) each of which emits a signal. Emitted as the signal by the emitting section 41 is light, radio waves, or the like. Examples of the light encompass visible light, infrared light, ultraviolet light, and laser beams thereof. In an example, the emitting section 41 two-dimensionally or three-dimensionally emits light or the like to a subject to be measured (i.e., a measurement subject); then, the distance measuring section 40 detects reflected light generated in response to the emitted light, and obtains three-dimensional point cloud data of the measurement subject on the basis of a time taken from the timing of emission of the light to the timing of detection of the reflected light. Note that the distance measuring method is not limited to this. In place of light, radio waves may be used to carry out the distance measurement. The distance measurement principle may be triangulation, rather than time-of-flight.

The extracting section 11 of the abnormal position detecting device 1 extracts, on the basis of a reflection signal generated in response to a signal that one of the plurality of emitting sections 41i included in the distance measuring device 40 has emitted to the subject, a part of the surface of the subject which part has an abnormal change, the extracting being carried out for each of the plurality of emitting sections 41i. The specifying section 12 specifies a region of the surface, the region including parts of the surface which parts have been extracted in relation to two or more of the plurality of emitting sections 41i.

As discussed above, the abnormal position detecting device 1 in accordance with the present example embodiment is configured to: extract, on the basis of a reflection signal generated in response to a signal that one of the plurality of emitting sections 41i included in the distance measuring device 40 has emitted to the subject, a part of the surface of the subject which part has an abnormal change, the extracting being carried out for each of the plurality of emitting sections 41i; and specify a region of the surface, the region including parts of the surface which parts have been extracted in relation to two or more of the plurality of emitting sections 41i. Thus, the abnormal position detecting device 1 in accordance with the present example embodiment brings about an effect of making it possible to specify (a) a part actually having an abnormal change in a surface or (b) a region including the part.

(Flow of Abnormal Position Detection Method)

The following will describe, with reference to FIG. 2, a flow of an abnormal position detection method S1 in accordance with the present example embodiment. FIG. 2 is a flowchart illustrating a flow of the abnormal position detection method S1 in accordance with the present example embodiment.

As shown in FIG. 2, the abnormal position detection method S1 includes steps S11 and S12. In step S11, at least one processor (e.g., the extracting section 11) extracts, on the basis of a reflection signal generated in response to a signal that one of the plurality of emitting sections 41i included in the distance measuring device has emitted to a subject, a part of a surface of the subject which part has an abnormal change, the extracting being carried out for each of the plurality of extracting sections 41i.

Next, in step S12, at least one processor (e.g., the specifying section 12) specifies a region of the surface, the region including parts of the surface which parts have been extracted in relation to two or more of the emitting sections 41i.

As discussed above, the abnormal position detecting method S1 in accordance with the present example embodiment is configured to include the steps of: extracting, on the basis of a reflection signal generated in response to a signal that one of the plurality of emitting sections 41i included in the distance measuring device has emitted to a subject, a part of the surface of the subject which part has an abnormal change, the extracting being carried out for each of the plurality of emitting sections 41i; and specifying a region of the surface, the region including parts of the surface which parts have been extracted in relation to two or more of the plurality of emitting sections 41i. Thus, the abnormal position detecting method S1 in accordance with the present example embodiment gives an effect of making it possible to specify (a) a part actually having an abnormal change in a surface or (b) a region including the part.

### Second Example Embodiment

Next, the following description will discuss a second example embodiment of the present invention in detail with reference to the drawings.

(Configuration of Abnormal Position Detecting System 2A)

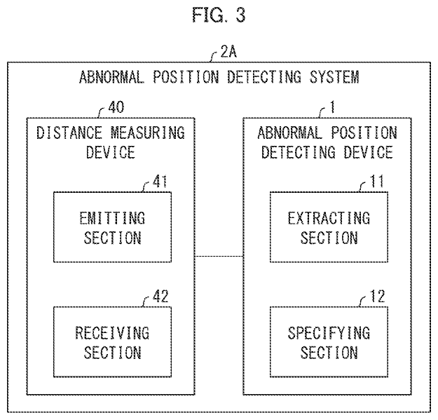

The following will describe, with reference to FIG. 3, a configuration of an abnormal position detecting system 2A in accordance with the present example embodiment. FIG. 3 is a block diagram illustrating a configuration of the abnormal position detecting system 2A. The abnormal position detecting system 2A is a device that detects deformation of a surface of a structure. The deformation may be, for example, an abnormal change in the surface. In the present example embodiment, the structure is architecture such as a building, a tunnel, a bridge, a wall, or a road. Such a structure gradually reduces its strength as a result of, e.g., exfoliation of concrete that may occur due to deterioration over time. Therefore, such a structure requires periodical inspection.

Instead of a visual inspection by a worker, a structure may sometimes be inspected by a method that uses a distance measuring device to detect a change in a surface profile of the structure and, on the basis of a result of the detection, detects an abnormal change in the surface of the structure. If the surface profile that the structure is supposed to originally have is changed at a certain position, an abnormality (or an abnormal change) such as exfoliation or collapse may occur at the certain position. In a case where the distance measuring device is used to detect an abnormal change, a signal from the distance measuring device typically includes a measurement error, a noise, and/or the like. For this reason, it is sometimes difficult to determine whether or not the result of the detection indicates an actual abnormality (or an actual abnormal change). If an actual abnormality is missed, this may lead to a serious accident. In order to avoid this, an abnormality should be detected properly. However, if an attempt is made to carry out detection so as not to miss any change, a lot of changes that are not actual abnormalities may be detected. Consequently, the worker requires much efforts to check if each of the detected changes is an actual abnormal position. The abnormal position detecting system 2A in accordance with the present example embodiment obtains, by the distance measuring device, plural pieces of surface profile data (distance measurement data sets). Then, the abnormal position detecting system 2A specifies (a) a piece of distance measurement data (abnormal change) for which a change (abnormal change) in surface profile has been determined in common among the plural pieces of surface profile data or (b) a region including such plural pieces of surface profile data. This makes it possible to eliminate a measurement error, a noise, and the like that may otherwise occur in the process of detecting an abnormal change in the surface.

As shown in FIG. 3, the abnormal position detecting system 2A includes an abnormal position detecting device 1 and a distance measuring device 40. The abnormal position detecting device 1 includes an extracting section (extracting means) 11 and a specifying section (specifying means) 12. The abnormal position detecting device 1 obtains surface profile data obtained by the distance measuring device 40.

Note that, in the example embodiment shown in FIG. 3, the extracting section 11 and the specifying section 12 of the abnormal position detecting device 1 are integrated so as to constitute the single abnormal position detecting device 1. However, the extracting section 11 and the specifying section 12 do not necessarily need to be integrated so as to constitute the single abnormal position detecting device 1. Alternatively, for example, the extracting section 11 and the specifying section 12 may be arranged separately. Further, the extracting section 11 and the specifying section 12 may be connected with each other via wired communication, radio communication, or a dedicated line. Further alternatively, the whole of or part of the extracting section 11 and the specifying section 12 may be loaded on the cloud. This also applies to the below-indicated device configurations.

(Distance Measuring Device 40)

The distance measuring device 40 includes n emitting sections (emitting means) 41i (i=an integer of 1 to n) each configured to emit a signal and n receiving sections (receiving means) 42i (i=an integer of 1 to n) each configured to receive a reflection signal generated in response to a signal emitted from a corresponding one of the emitting sections 41i. The emitting section that emits a signal to a subject and the receiving section that receives a reflection signal generated in response to the signal are collectively called a “channel”. In other words, the channel includes the emitting section that emits a signal to the subject and the receiving section that receives a reflection signal generated in response to the signal. The distance measuring device 40 includes a plurality of channels. The plurality of channels may also collectively be called a “signal part”.

The distance measuring device 40 emits a signal to a subject and obtains a reflection signal generated in response to the signal thus emitted. The distance measuring device 40 works out a distance to a reflection point on the basis of a time taken from the timing of emission of the signal to the timing of obtaining the reflection signal. On the basis of a direction of emission of the signal and the distance thus worked out, the distance measuring device 40 obtains three-dimensional coordinates of the reflection point. The principle of measuring the distance and direction is not limited to the above-discussed example. For example, the distance measuring device may be a three-dimensional Light detection and ranging (Lidar). Lidar refers to a distance measuring device that intermittently emits light to a subject, receives (detects), by the receiving section 42, reflected light reflected at each reflection point (in the present example embodiment, a single point on a surface of the structure) of the subject, and works out a distance on the basis of a time taken from the emission to the reception. The three-dimensional Lidar obtains, as point cloud data, sets of three values representing three-dimensional coordinates of a plurality of positions (points) on the surface of the structure seen from the emitting section 41 that has emitted the light. Hereinafter, for convenience of explanation, the set of the three values representing the three-dimensional coordinates may also be simply expressed as “three-dimensional coordinates”. The point cloud data refers to a group of three-dimensional coordinates of a plurality of points. The direction of the reflection point is obtained as a direction of emission of light. Examples of the light encompass visible light, infrared light, ultraviolet light, and laser beams thereof. The light is an aspect of the “signal”. The three-dimensional Lidar two-dimensionally or three-dimensionally emits light to a subject to be measured (i.e., a measurement subject), and detects reflected light generated in response to the emitted light. Then, on the basis of a time taken from the timing of emission of the light to the timing of detection of the reflected light, the three-dimensional Lidar obtains three-dimensional point cloud data of a surface of the measurement subject. Note that the distance measuring method is not limited to this. The distance measurement may be carried out with use of radio waves in place of light. The distance measurement principle may be triangulation, rather than time-of-flight.

A distance measurement set, which includes the emitting section 41i and the receiving section 42i, carries out distance measurement for a single point on a surface of the subject at a certain timing. The distance measuring device 40 includes a plurality of such distance measurement sets. The plurality of distance measurement sets carry out, at a certain timing, distance measurement on at least a part of a region of a surface of a subject in such a manner that the plurality of distance measurement sets carry out the distance measurement for respective different points in the part of the region. In other words, a single set of the emitting section 41i and the receiving section 42i carries out distance measurement with respect to a single point in the part of the range. The plurality of distance measurements carry out distance measurement on another region of the surface of the subject in a similar manner. Consequently, discrete distance measurement data over the entire surface of the subject is obtained. All pieces of distance measurement data obtained by the single set of the emitting section 41i and the receiving section 42i are referred to as a “distance measurement data set”. In this case, a plurality of distance measurement data sets are obtained by the plurality of sets of the emitting section 41i and the receiving section 42i. The distance measurement data set includes plural pieces of data indicating positions of points on the surface of the subject (structure) that are measured by the single distance measurement set. In this case, such a distance measurement data set can be expressed as surface profile data indicating the shape (positions) of the surface of the subject. The distance measurement data set can alternatively be expressed as including plural pieces of data indicating positions of points on the surface of the subject. Hereinafter, the “distance measurement data set” will be simply referred to as a “data set”. In the description below, the “distance measurement set of the emitting section 41i and the receiving section 42i” may simply be called an “emitting section 41i” occasionally. The plurality of distance measurement data sets may not necessarily be data sets different for the distance measurement sets. For example, the distance measurement data set may be a single data set that allows for identification of a distance measurement set. In this case, the distance measurement data set may be, for example, a set including (a) a point on the surface and (b) an identifier indicating a distance measurement set that has obtained the point, the point and the identifier being associated with each other.

(Abnormal Position Detecting Device 1)

In an example, the extracting section 11 of the abnormal position detecting device 1 may (a) generate, on the basis of the reflection signals, a data set which includes plural pieces of data indicating positions on a surface and which allows for identification of a corresponding one of the emitting sections 41i and (b) extract a part having an abnormal change with use of the generated data set, the extracting being carried out for each of the plurality of emitting sections 41i. That is, the extracting section 11 extracts, from the distance measurement data set obtained in relation to each of the plurality of emitting sections 41i included in the distance measuring device 40, a part having a change in surface profile of the subject (hereinafter, such a part will be referred to as a “changed part”), the extracting being carried out for each of the distance measurement data sets. The expression “change in surface profile” means the surface profile that the structure is supposed to originally have has been changed. That is, the “changed part” can be expressed as a “part having an abnormal change in the original shape of the structure”. In an example, the extracting section 11 extracts, as a changed part having a change in the surface profile, a part of the surface of the subject which part has a pattern different from the patterns of plural pieces of surface profile data of adjacent regions.

The specifying section 12 may (a) determine, for each of a plurality of regions included in the surface, the number of emitting sections 41i in relation to which an abnormal change has been extracted, and (b) specify, among the plurality of regions, a region for which the determined number satisfies a criterion for determination of the presence or absence of an abnormal change. Alternatively, the specifying section 12 may specify, on the basis of data sets from the respective different emitting sections 41i, (a) a part in which changed parts extracted from respective different pieces of distance measurement data are arranged relatively densely or (b) a region including a plurality of changed parts. The expression “arranged relatively densely” means that the changed parts are arranged more densely therein than in other parts of the surface (i.e., the density of the changed parts therein is larger than in other parts). For example, the region may be a region within a range of a certain distance from one changed part. Alternatively, the region may be one of regions into which the surface of the subject is divided arbitrarily. In other words, in a case where a given number or more of the plurality of distance measurement sets extract, as a changed part, a point in a certain region, the certain region is determined as a part in which changed parts are arranged densely. The given number of sets is two or more, for example. In this case, the condition “the given number or more” can be rephrased as a criterion for determination of the presence or absence of an abnormal change. The given number of sets may be a given number of distance measurement sets (or channels). In a case where the number of distance measurement sets that have specified a changed part in a certain region satisfies the criterion for determination of the presence of an abnormal change, the specifying section 12 determines that the certain region is a region having an abnormal change.

The abnormal position detecting device 1 is a device configured to: extract, from each of the data sets indicating the surface of the subject which data sets are obtained in relation to the respective emitting sections 41i included in the distance measuring device 40 configured to emit signals, a changed part having a change in surface profile; and specify, on the basis of the data sets obtained in relation to the respective different emitting sections 41, (a) a plurality of changed parts arranged relatively densely or (b) a region including the plurality of changed parts. Hereinafter, a target to be specified by the abnormal position detecting device 1 (i.e., a plurality of changed parts or a region including the plurality of changed parts) may be referred to as a “region” occasionally.

The data set is, for example, distance measurement data of an inspection range of the structure that is the subject. In a case where the three-dimensional Lidar is used, the data set is point cloud data of an inspection range of the structure. The distance measuring device 40 obtains a plurality of data sets of an inspection range of the structure.

The data set is, for example, a group of three-dimensional coordinates using, as an origin, a point from which light is emitted, i.e., the position of the emitting section 41i. When the distance measuring device moves, the origin of the coordinate data is also shifted. In order to determine an abnormal change with use of a plurality of distance measurement data sets, the data sets are registered to common coordinates before the data sets are processed by the abnormal position detecting device 1. The common coordinates may be, for example, world coordinates. Note that the registration may be carried out by the extracting section 11 or the specifying section 12. Alternatively, a processing section that carries out the registration process may be separately provided. The data sets registered to the world coordinates may be stored in a database.

The user may carry the distance measuring device 40 along the subject so as to allow the distance measuring device 40 to obtain data sets of the subject. Alternatively, the user may cause a vehicle having the distance measuring device 40 mounted thereon to travel along the subject so as to allow the distance measuring device 40 to obtain data sets of the subject. Further alternatively, the user may cause a flight vehicle (e.g., a drone) having the distance measuring device 40 mounted thereon to fly along the subject so as to allow the distance measuring device 40 to obtain data sets of the subject. Since the distance measuring device 40 includes the plurality of distance measurement sets each including the emitting section 41i and the receiving section 42i, it is possible to obtain a plurality of data sets by distance measurement carried out a single time.

As stated above, the specifying section 12 specifies, on the basis of the data sets obtained in relation to the different emitting sections 41i, a region from which a plurality of changed parts have been extracted. In a case where only a single distance measurement set of the emitting section 41 and the receiving section 42 extracts a changed part, there is a possibility that the extraction might have been caused by a distance measurement error and/or a noise. Meanwhile, in a case where two or more distance measurement sets of the emitting section 41i and the receiving section 42i extract changed parts arranged densely, the possibility that the extraction is caused by a distance measurement error and/or a noise is lowered. In a case where a plurality of distance measurement sets emit signals to respective different points in a certain region at a single timing and changed parts are specified on the basis of reflection signals generated in response to the signals, the possibility that a noise is also detected is further lowered, thanks to the plurality of distance measurement sets. Thus, the region from which changed parts arranged densely are extracted by the plurality of distance measurement sets each including the emitting section 41i and the receiving section 42i is more highly likely to have deformation (abnormality) actually occurring therein than a region from which a changed part is extracted by a single set of the emitting section 41 and the receiving section 42. That is, the specifying section 12 specifies, among the regions determined to have a change in surface profile on the basis of the data sets obtained by the distance measuring device 40, (a) a plurality of changed parts determined have a change in surface profile with a high reliability or (b) a region including the plurality of changed parts. The reason why the “region including the plurality of changed parts” is specified is that the positions of the plurality of changed parts are not completely the same but are slightly different from each other.

As discussed above, the abnormal position detecting device 1 in accordance with the present example embodiment is configured to: extract, from each of data sets which are respectively obtained in relation to the respective plurality of emitting sections 41i included in the distance measuring device 40 configured to emit signals and which indicate a surface profile of a subject, a changed part having a change in the surface profile; and specify, on the basis of the data sets obtained in relation to the respective different emitting sections 41i, (a) a plurality of changed parts arranged relatively densely or (b) a region including the plurality of changed parts. Thus, the abnormal position detecting device 1 in accordance with the present example embodiment brings about an effect of making it possible to specify, on the basis of the distance measurement data obtained by the distance measuring device 40, (a) a changed part having a high reliability of actual occurrence of an abnormal change in surface or (b) a region including the changed part.

Alternatively, the abnormal position detecting device 1 in accordance with the present example embodiment can be rephrased as being configured to: extract, on the basis of a reflection signal generated in response to a signal that one of a plurality of emitting means included in a distance measuring device has emitted to a subject, a part of the surface of the subject which part has an abnormal change, the extracting being carried out for each of the plurality of emitting means; and specify a region including parts of the surface which parts have been extracted in relation to two or more of the plurality of emitting means. Further alternatively, the abnormal position detecting device 1 can be rephrased as being configured to include: a signal section that includes a plurality of channels; and a specifying section. In this case, the specifying section specifies, on the basis of a reflection signal, a part of a surface of a subject which part has an abnormal change in the surface, the specifying being carried out for each of the plurality of channels. Then, the specifying section specifies a region including parts of the surface which parts have been specified in relation to two or more of the plurality of channels. Thus, it is possible to bring about an effect of making it possible to specify (a) a parts actually having an abnormal change in surface or (b) a region including the part.

### Third Example Embodiment

The following description will discuss a third example embodiment of the present invention in detail with reference to the drawings. Note that members having identical functions to those of the first example embodiment are given identical reference signs, and a description thereof will be omitted.

(Configuration of Abnormal Position Detecting System 2B)

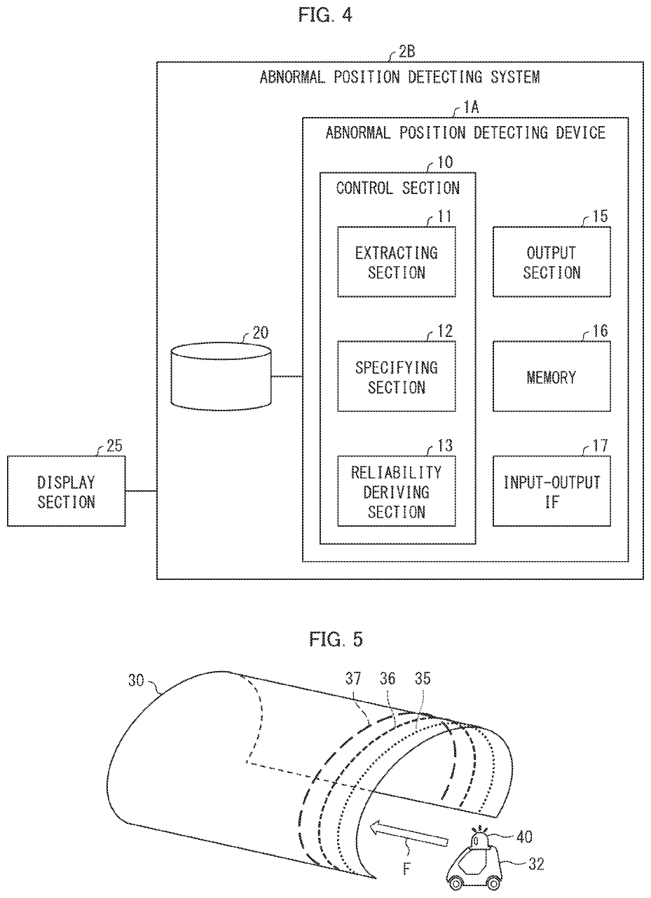

FIG. 4 is a block diagram illustrating a configuration of an abnormal position detecting system 2B in accordance with a third example embodiment of the present invention. As shown in FIG. 4, the abnormal position detecting system 2B includes an abnormal position detecting device 1A and a database 20. The abnormal position detecting device 1A includes a control section 10, an output section 15, a memory 16, and an input-output interface (input-output IF) 17. The control section 10 includes an extracting section 11, a specifying section 12, and a reliability deriving section 13. The abnormal position detecting system 2B is connected with a display section 25.

The control section 10 includes at least one processor (not illustrated). The processor reads and executes various programs stored in the memory 16, thereby realizing the functions of the extracting section 11, the specifying section 12, and the reliability deriving section 13. Alternatively, as described later, the functions of these sections may be realized by, in place of the programs, hardware such as a dedicated integrated circuit (IC chip).

The output section 15 outputs information specified by the specifying section 12 to the display section 25 via the input-output IF. The memory 16 stores therein data such as the various programs, the information specified by the specifying section 12, and/or a given range. The input-output IF 17 is an interface via which the abnormal position detecting system 2B carries out information communication with an external entity.

The extracting section 11 basically has similar functions to those of the extracting section 11 described in the second example embodiment. However, while the extracting section 11 of the second example embodiment obtains the distance measurement data from the distance measuring device 40, the extracting section 11 of the third example embodiment obtains the distance measurement data from the database 20. On this point, the extracting section 11 of the third example embodiment differs from the extracting section 11 of the second example embodiment. Details of the extracting section 11, the specifying section 12, and the reliability deriving section 13 will be described later.

The database 20 stores therein a plurality of data sets obtained by the distance measuring device 40 (e.g., three-dimensional Lidar). The data sets obtained by the three-dimensional Lidar are point cloud data sets. As described in the second example embodiment, the plurality of data sets may be obtained by (a) carrying out a single measurement with use of the plurality of distance measurement sets of the emitting section 41i and the receiving section 42i or (b) repeating, plural times, operation of obtaining a single data set with use of a single set of the emitting section 41 and the receiving section 42.

In the case of the distance measuring device 40 including a plurality of distance measurement sets, each point cloud data obtained by a certain distance measurement set and identification data indicating the certain distance measurement set are associated with each other at the time of obtaining the point cloud data. In a case where the plurality of data sets are the ones obtained by a single distance measurement set carrying out, a plurality of times, operation of obtaining a data set, used as identification information is a time when the measurement was carried out, the time being associated with a corresponding one of the data sets, for example. The point cloud data is given a time when the measurement was carried out. Therefore, it is possible to determine, on the basis of the time, in which time slot a certain changed part was measured as point cloud data.

FIG. 5 is a view schematically illustrating a method for obtaining a plurality of data sets by three-dimensional Lidar. FIG. 5 is a view schematically illustrating how distance measurement data of an inner surface of a tunnel 30 is obtained with use of the distance measuring device 40 mounted on a mobile vehicle 32. The distance measuring device 40 includes three sets of the emitting section 41i (i=1, 2, 3) and the receiving section 42i (i=1, 2, 3). Thus, it is possible to obtain three data sets by measurement carried out a single time. As shown in FIG. 5, the emitting section 41i carries out scanning with a laser beam along a direction intersecting a traveling direction F of the mobile vehicle 32. The intersecting direction may be set at an angle of approximately 80° to approximately 100° with respect to the traveling direction F. In the example shown in FIG. 5, the scanning is carried out in a direction substantially perpendicular (approximately at 90°) to the traveling direction F.

FIG. 5 shows a range 35 of scanning carried out a single time for point cloud data to be obtained with an emitting section 411 and a receiving section 421, a range 36 of scanning carried out a single time for point cloud data to be obtained with an emitting section 412 and a receiving section 422, and a range 37 of scanning carried out a single time for point cloud data to be obtained with an emitting section 413 and a receiving section 423. For example, the emitting sections 411, 412, and 413 emit laser beams toward the inner wall of the tunnel at a certain timing. The receiving section 421 obtains reflected light generated in response to a laser beam emitted by the emitting section 411. The receiving section 422 obtains reflected light generated in response to a laser beam emitted by the emitting section 412. The receiving section 423 obtains reflected light generated in response to a laser beam emitted by the emitting section 413. In FIG. 5, for facilitating understanding, the three scanning ranges are depicted as being distant from each other. Actually, however, the three scanning ranges are arranged close to each other. For example, even if three data sets obtained by distance measurement carried out a single time are spaced from each other by several cm, it is possible to adequately detect a dent having a width of approximately 10 cm. Further, in the example shown in FIG. 5, the distance measuring device 40 is mounted on the mobile vehicle 32. Alternatively, a worker (user) may move through the tunnel while carrying the distance measuring device 40.

The distance measurement device 40 obtains distance measurement data at, e.g., 20 frames/sec. Given that data obtained as a result of scanning carried out a single time is stored in one frame, obtained as the distance measurement data is the one resulting from scanning carried out 60 times in total by three sets of the emitting section 41i and the receiving section 42i in a range across which the mobile vehicle 32 travels in one second. The data sets are obtained while the position of the origin is moving along with the movement of the mobile vehicle 32. Thus, for example, the obtained data sets are transformed into (registered to) world coordinates, and are then transmitted to the database 20 so as to be stored therein. The coordinate transformation can be carried out with use of an Inertial Measurement Unit (IMU) or a technique such as Simultaneous Localization and Mapping (SLAM). The coordinate transformation may be carried out by a coordinate transforming section (not illustrated) included in the distance measuring device 40.

Alternatively, the abnormal position detecting system 2B may carry out the coordinate transformation on the obtained data sets and then store a resultant in the database 20. The data sets obtained by the distance measuring device 40 may be transmitted to the database 20 via an information network such as the Internet, for example.

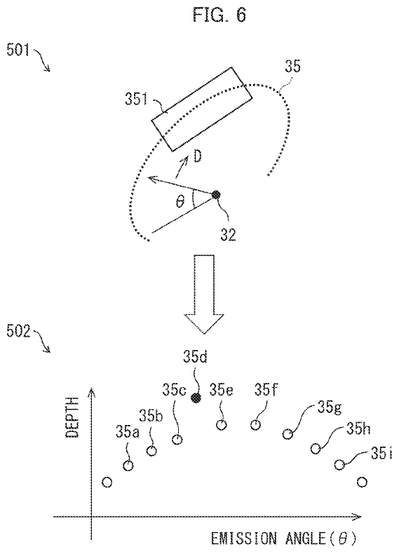

Next, the following will describe a method according to which the extracting section 11 extracts a changed part having a change in surface profile. FIG. 6 is a view schematically illustrating the method according to which the extracting section 11 extracts a changed part having a change in surface profile. “501” in FIG. 6 shows a direction in which the distance measuring device 40 carries out laser scanning. For example, the distance measuring device 40 carries out scanning from the mobile vehicle 32 in such a manner that the scanning takes place, in a plane substantially perpendicular to the road surface, along a direction indicated by the arrow D starting from a direction being substantially in parallel with a road surface and which being substantially perpendicular to a traveling direction of the distance measuring device 40. In this case, the scanning angle θ is approximately 180° at maximum. In a case where the distance measuring device 40 is at a certain height from the road surface, the scanning range may be a range having a wider scanning angle.

“502” in FIG. 6 shows an example of a graph indicating a relation between an emission angle θ and a depth. The “depth” refers to a distance from an origin to an inner surface of the tunnel 30. For example, assume that distance measurement data from 35a to 35i is distance measurement data included in a range 351 shown in 501 of FIG. 6. The range 351 is around the top of the tunnel 30. In the range 351, the depth gently increases along with increase of the emission angle θ; and the depth gently decreases after the emission angle θ stops increasing. Referring to the graph shown in 502, among pieces of distance measurement data 35a to 35i, only a piece of distance measurement data indicated by the reference sign 35d deviates from a gentle curve formed by the other pieces of data and exhibits a large amount of change in depth. That is, the piece of distance measurement data 35d suggests that a dent exists at that location on the surface. Thus, the extracting section 11 extracts the piece of distance measurement data 35d as a changed part. In this manner, the extracting section 11 may extract the changed part by referring to the amount of change in the depth to the surface of the subject. Further, the extracting section 11 may extract the changed part by referring to the amount of change in the depth along a direction intersecting the traveling direction of the distance measuring device. The “direction intersecting the traveling direction of the distance measuring device” may be a direction in which the distance measuring device 40 carries out laser scanning.

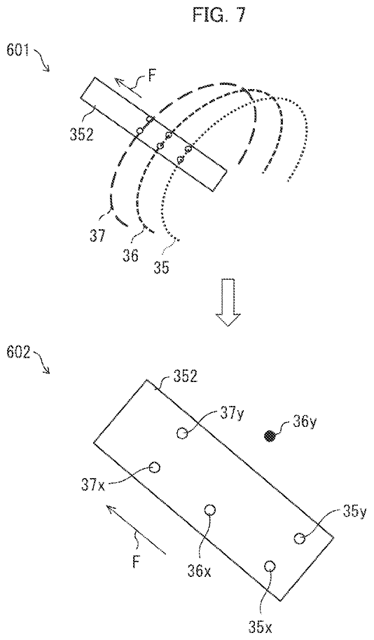

FIG. 7 is a view schematically illustrating another method according to which the extracting section 11 extracts a changed part having a change in surface profile. “601” in FIG. 7 shows the position (range) 352 on the surface of the tunnel 30 estimated on the basis of a plurality of data sets. Given that (a) longer sides are defined along the traveling direction F of the distance measuring device 40 and (b) shorter sides are defined along a direction substantially perpendicular to the traveling direction F and are set to have a small value, the position 352 on the surface can be considered as a substantially flat rectangle 352. As shown in 602 in FIG. 7, the rectangle 352 includes pieces of distance measurement data 35x and 35y of the scanning range 35, a piece of distance measurement data 36x of the scanning range 36, and pieces of distance measurement data 37x and 37y of the scanning range 37. Meanwhile, a piece of the distance measurement data 36y of the scanning range 36 is slightly distant from a surface of the rectangle 352. Typically, the inner surface of the tunnel is constituted by a surface having a uniform curve. Therefore, a piece of distance measurement data, like the piece of distance measurement data 36y, distant away from a flat or curved surface in which other pieces of distance measurement data exist can be extracted as a changed part. That is, the extracting section 11 may extract the changed part by referring to a distance between (a) the position on the surface estimated on the basis of the plurality of data sets and (b) the changed part. Alternatively, the extracting section 11 may extract the changed part by referring to a distance between (a) the position on the surface obtained along the traveling direction F of the distance measuring device 40 and (b) the changed part.

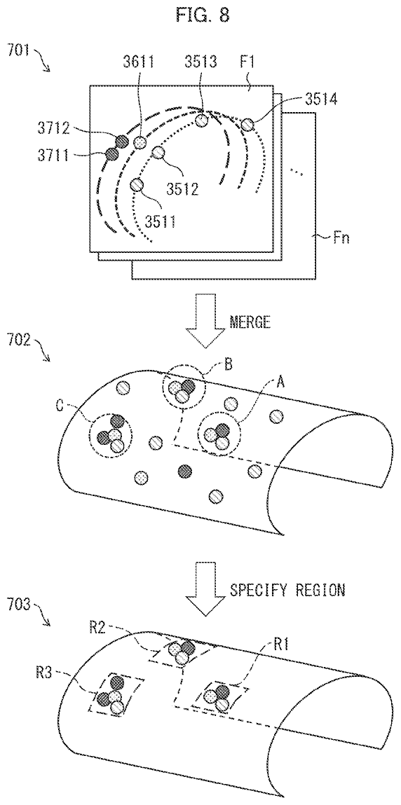

Next, the following will describe a method, executed by the specifying section 12, for specifying a plurality of changed parts arranged relatively densely or a region including the plurality of changed parts. FIG. 8 is a view schematically illustrating the method for specifying the region including the plurality of changed parts arranged relatively densely (hereinafter, such a region will be referred to as a “dense arrangement region”). The specifying section 12 may specify the region by referring to the number of changed parts associated with other emitting sections 41i (data sets) located within a given range from a certain changed part.

“701” in FIG. 8 shows changed parts that the extracting section 11 has extracted from scanning data included in a frame F1 out of a plurality of frames F1 to Fn. In the frame F1, pieces of distance measurement data 3511, 3512, 3513, and 3514 are extracted as changed parts from the scanning range 35. Further, a piece of distance measurement data 3611 is extracted as a changed part from the scanning range 36. Further, pieces of distance measurement data 3711 and 3712 are extracted as changed parts from the scanning range 37. Note that an actual frame includes a larger number of pieces of scanning data. In all of the frames F1 to Fn, changed parts are extracted in a similar manner.

Next, as shown in 702, in a state where all the changed parts are registered to the world coordinates, searching for a range in which a plurality of changed parts are arranged relatively densely is carried out on the basis of the data sets associated with the respective different emitting sections 41i (distance measurement sets). For example, see the range A in 702. In the range A, changed parts, one each from the scanning ranges 35, 36, and 37, are dense in a narrow range. This is true also of the range B. In the range C, changed parts, one each from the scanning ranges 35 and 36 and two from the scanning range 37, are dense in a narrow range.

In such a case, as shown in 703 in FIG. 8, the specifying section 12 specifies the range A as a dense arrangement region R1; the specifying section 12 specifies the range B as a dense arrangement region R2; and the specifying section 12 specifies the range C as a dense arrangement region R3. The output section 15 outputs, to the display section 25 via the input-output IF, information regarding the dense arrangement regions R1, R2, and R3 thus specified. The display section 25 is, for example, a display. The display section 25 displays the information regarding the dense arrangement regions R1, R2, and R3. The information regarding the dense arrangement regions R1, R2, and R3 is, for example, data indicating the number of changed parts included in the dense arrangement regions R1, R2, and R3, the positions thereof, and/or the like.

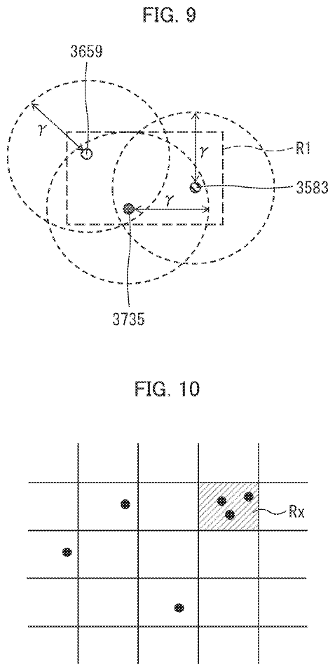

Next, the following will provide a specific description of a method for searching for a range in which changed parts extracted on the basis of a plurality of data sets are dense. FIG. 9 is a view schematically illustrating a specific example of a method according to which the specifying section 12 specifies a dense arrangement region. For example, a focus is place on a changed part 3735. Then, searching is carried out to determine whether or not a changed part extracted based on another data set exists within a given range (distance) from the changed part 3735. The given range can be determined, for example, on the basis of at least any one selected from the group consisting of a distance measurement error, a magnitude of a noise, and a coordinate transformation error occurring in transforming the data sets into common coordinates (e.g., the world coordinates).

According to the extraction carried out on the basis of whether or not the amount of change in depth is not less than the distance measurement error, the magnitude of the noise, or the coordinate transformation error occurring in transformation into the common coordinates, the one extracted as a changed part in a plural pieces of distance measurement data is considered to have a low possibility of being caused by any of these errors. Therefore, it is possible to eliminate, as much as possible, a changed part caused by the distance measurement error, the magnitude of the noise, or the coordinate transformation error occurring in transformation into the common coordinates. When the coordinate transformation is carried out by SLAM, there is a possibility that the coordinate transformation error may increase. The reason is that an error occurring in deriving an amount of change in position becomes greater in an environment in which there is no landmark in the background, like a space inside a tunnel. In such a case, the above-described given range may be set with use of the coordinate transformation error.

For example, a given distance preliminarily determined is stored as “r” in the memory 16. In this case, as shown in FIG. 9, searching is carried out to determine whether or not another changed part is present within the circle, indicated by the broken line, having a radius r from the changed part 3735. Here, there are changed parts 3583 and 3659 within the distance r. The changed parts 3583 and 3659 are obtained from the data sets different from that of the changed part 3735 which is in focus. In this case, the specifying section 12 specifies, as a dense arrangement region R1, a region including the changed parts 3735, 3583, and 3659.

Next, a focus is place on a changed part 3583. Searching is carried out to determine whether or not another changed part is present within the circle, indicated by the broken line, having a radius r from the changed part 3583. Here, there is a changed part 3735 within the distance r. The changed parts 3583 and 3735 are obtained from different data sets. Thus, the specifying section 12 specifies a region including the changed parts 3583 and 3735 (the region is not illustrated). Subsequently, focusing on a changed part 3659, searching is carried out in a similar manner. Consequently, the specifying section 12 specifies a region including the changed parts 3659 and 3735 (the region is not illustrated).

The specifying section 12 may specify one of a plurality of regions into which the inner surface of the tunnel is arbitrarily divided. FIG. 10 is a view schematically illustrating how the specifying section 12 specifies one of quadrangular regions into which the inner surface of the tunnel is divided. The black dots (•) in FIG. 10 are extracted changed parts plotted in a drawing showing the divided regions. The region indicated as “Rx” in FIG. 10 has three changed parts. Assume that the three changed parts are the ones extracted from respective different data sets. In this case, the specifying section 12 may determine the region Rx as a dense arrangement region Rx.

Instead of the region, the specifying section 12 may specify the plurality of changed parts arranged relatively densely themselves. Taking the case shown in FIG. 9 as an example, the specifying section 12 may focus on the changed part 3735 and specify, as the “changed parts arranged densely”, the changed parts 3583 and 3659 which are extracted based on other data sets being within the given distance from the changed part 3735. Similarly, the specifying section 12 may focus on the changed part 3583 and specify the changed part 3732 within the given range. Then, the specifying section 12 may determine the changed parts 3583 and 3735 as the “changed parts arranged densely”. This is true also for the changed part 3659.

The abnormal position detecting device 1A may include a reliability deriving section 13. In an example, the reliability deriving section 13 derives a reliability of a certain changed part on the basis of the number of changed parts associated with the plurality of emitting sections 41i (data sets) within the given range.

For example, referring to FIG. 9, assume that a focus is made on the changed part 3735. Then, there are two changed parts (3583 and 3735) associated with other data sets within the given range from the changed part 3735. Then, the reliability deriving section 13 derives “2” for the reliability of the changed part 3735, for example. Meanwhile, in a case where a focus is made on the changed part 3583, there is one changed part (3735) associated with another data set within the given range from the changed part 3583. Then, the reliability deriving section 13 derives “1” for the reliability of the changed part 3583, for example. The more changed parts which are based on other data sets are located in the vicinity of a certain changed part, the higher reliability that the certain changed part has an actual profile change becomes. This makes it possible to carry out a measure efficiently. For example, a worker can carry out visual observation on the changed part having a high reliability.

The reliability deriving section 13 may derive a reliability of a certain changed part by referring to a weight of the data set of the emitting section 41i (data set) which weight has been set on the basis of the number of changed parts associated with that emitting section. The weight may be set by the reliability deriving section 13 with reference to the data sets for the distance measurement sets, or may be set by user's input.

In some cases, the distance measurement sets may have respective characteristics. For example, a data set obtained by a certain distance measurement set may have a relatively large error. Conversely, a data set obtained by another distance measurement set may have a relatively small error. In such a case, for the distance measurement data obtained by the distance measurement set involving a relatively large error, a reliability may be derived by multiplying a small weight. Conversely, for the distance measurement data obtained by the distance measurement set involving a relatively small error, a reliability may be derived by multiplying a large weight. This makes it possible to more finely determine a magnitude of a reliability.

The reliability deriving section 13 may derive a reliability of a region. For example, the reliability deriving section 13 can derive a high reliability for the region R1 shown in FIG. 9. Further, the reliability deriving section 13 can derive a high reliability for the region shown Rx in FIG. 10.

(Effects of Abnormal Position Detecting System 2B)

As discussed above, the abnormal position detecting system 2B in accordance with the present example embodiment includes the abnormal position detecting device 1A and the database 20. Thus, from the database 20 in which a data set obtained by the distance measuring device is stored, the data set can be obtained. Therefore, the abnormal position detecting system 2B in accordance with the present example embodiment can bring about, in addition to the effect given by the abnormal position detecting device 2 in accordance with the first example embodiment, an effect of making it possible to process, by the single abnormal position detecting device 1A, data sets obtained for a plurality of structures (subjects).

Further, the abnormal position detecting system 2B in accordance with the present example embodiment includes the abnormal position detecting device 1A provided with the reliability deriving section 13. Therefore, the abnormal position detecting system 2B in accordance with the present example embodiment can bring about, in addition to the effect given by the abnormal position detecting device 2 in accordance with the first example embodiment, an effect of making it possible to derive a reliability indicating whether or not a plurality of changed parts specified involve actual deformation.

### Fourth Example Embodiment

The following description will discuss a fourth example embodiment of the present invention in detail with reference to the drawings. Note that members having identical functions to those of the first to third example embodiments are given identical reference signs, and a description thereof will be omitted.

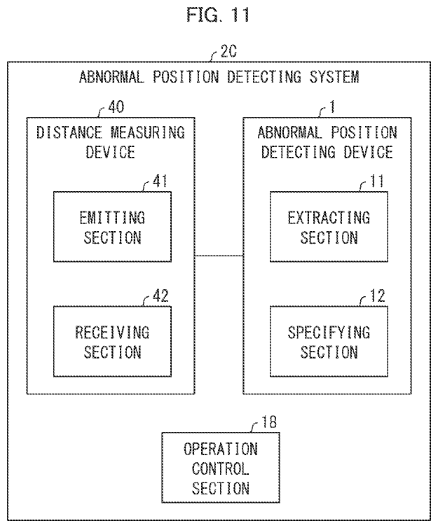

FIG. 11 is a block diagram illustrating a configuration of an abnormal position detecting system 2C in accordance with a fourth example embodiment of the present invention. The abnormal position detecting system 2C in accordance with the present example embodiment includes, in addition to the configuration of the abnormal position detecting system 2A in accordance with the second example embodiment, an operation control section 18. The operation control section 18 controls a device that can execute certain operation with respect to (a) a plurality of changed parts arranged relatively densely or (b) a region including the plurality of changed parts, the plurality of changed parts or the region having been specified by the specifying section 12.

The following will discuss the certain operation. In a case where the specifying section 12 specifies (a) a plurality of changed parts arranged relatively densely or (b) a region including the plurality of changed parts, the changed parts or the region (hereinafter, referred to as “specified information”) specified by the abnormal position detecting system 2 is output. In this case, it is necessary to check whether the specified information is wrong, whether the part is so deformed as to require a repair, and/or the like. The checking operation as above is referred to as “certain operation”.

Examples of such certain operation include operation of controlling, upon detection of output of the specified information, an optical camera or the like to capture an image of a changed part. In this case, the optical camera is a device that can execute the certain operation. In a case where this configuration is employed, the optical camera or the like, together with the distance measuring device 40, is mounted on the mobile vehicle 32. Upon detection of output of the specified information, the operation control section 18 controls the optical camera or the like to capture an image of a changed part. When the specified information is output, the worker or the operation control section 18 may cause the mobile vehicle 32 to travel backward to a position suitable for optical photographing.

Alternatively, the certain operation may be operation of changing a laser emitting direction of the distance measuring device 40 or causing the mobile vehicle 32 to travel backward to measure a depth of the changed part again. When the specified information is output, the operation control section 18 controls the distance measuring device 40 so that the distance measuring device 40 measures the depth of the changed part again.

Further alternatively, the certain operation may be operation of conducting a hammering test on the changed part. When the specified information is output, the operation control section 18 may control a hammering test device (not illustrated) mounted on the mobile vehicle 32 so that the hammering test device conducts a hammering test on the changed part. The hammering test may be a method according to which a worker strikes the surface with a hammer and makes a determination by hearing a sound generated thereby or a laser hammering test according to which vibrations are sent and received via a laser.

Still further alternatively, the certain operation may be operation of giving a marker that allows a person to identify the changed part. When the specified information is output, the operation control section 18 may control a sign adhering device (not illustrated) mounted on the mobile vehicle 32 so that the sign adhering device adheres, to the changed part, a sign identifiable by the worker. The sign adhering device emits a capsule containing a coloring agent, for example. When the capsule collides with the surface, the capsule breaks and the coloring agent adheres to the surface. Alternatively, the sign adhering device may emit a colored adhesive that adheres to the surface. The worker can check a part to which the coloring agent or the adhesive is attached so as to determine whether an abnormal change actually occurs therein and whether the abnormal change requires a repair.

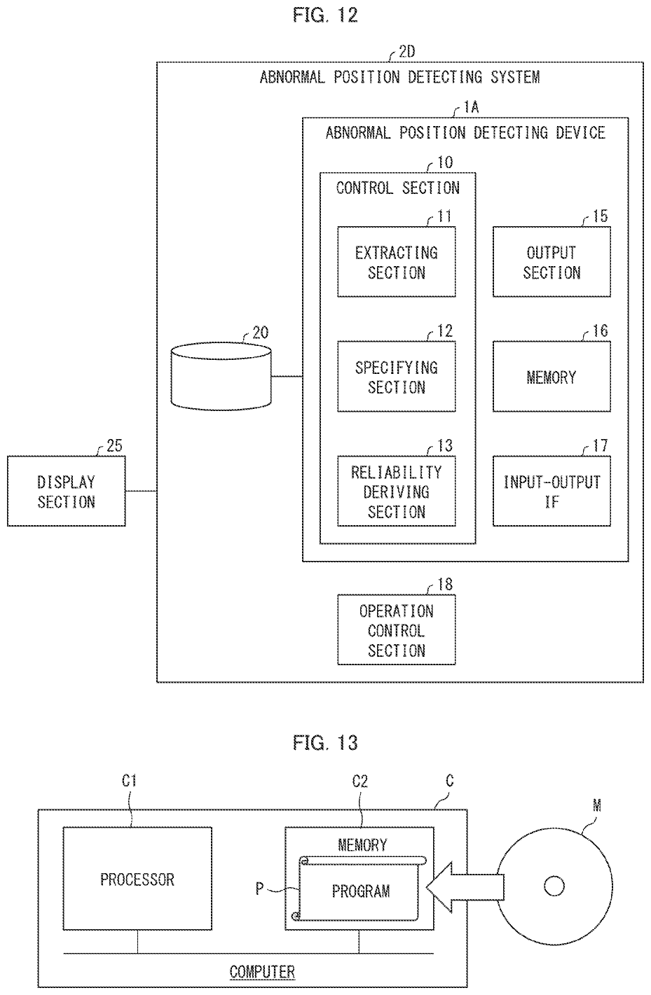

FIG. 12 is a block diagram illustrating a configuration of an abnormal position detecting system 2D in accordance with a fourth example embodiment of the present invention. The abnormal position detecting system 2D in accordance with the present example embodiment includes, in addition to the configuration of the abnormal position detecting system 2B in accordance with the third example embodiment, an operation control section 18. The operation control section 18 is similar to the operation control section 18 included in the above-discussed abnormal position detecting system 2C.

Each of the abnormal position detecting systems 2C and 2D in accordance with the fourth example embodiment include the operation control section 18. With this, the worker can determine whether or not the specified changed part actually has an abnormal change and whether the change requires a repair.

[Software Implementation Example]

Part of or the whole of functions of the abnormal position detecting systems 2, 2A, 2B, and 2C (hereinafter, referred to as “abnormal position detecting system 2 and the like”) can be realized by hardware such as an integrated circuit (IC chip) or can be alternatively realized by software.

In the latter case, the abnormal position detecting system 2 and the like are each realized by, for example, a computer that executes instructions of a program that is software realizing the foregoing functions. FIG. 13 shows an example of such a computer (hereinafter, referred to as a “computer C”). The computer C includes at least one processor C1 and at least one memory C2. The memory C2 has a program P stored therein, the program P causing the computer C to operate as the abnormal position detecting system 2 and the like. In the computer C, the processor C1 reads and executes the program P from the memory C2, thereby realizing the functions of the abnormal position detecting system 2 and the like.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by the computer C. Examples of the storage medium M encompass a tape, a disk, a card, a memory, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

[Supplementary Remarks 1]

The present invention is not limited to the example embodiments, but can be altered by a skilled person in the art within the scope of the claims. The present invention also encompasses, in its technical scope, any embodiment derived by combining technical means disclosed in differing embodiments.

[Supplementary Remarks 2]

Some or all of the above embodiments can be described as below. Note however that the present invention is not limited to aspects described below.

(Supplementary Note 1)

A device configured to: extract, on a basis of a reflection signal generated in response to a signal that one of a plurality of emitting means included in a distance measuring device has emitted to a subject, a part of a surface of the subject which part has an abnormal change, the extracting being carried out for each of the plurality of the emitting means; and specify a region of the surface, the region including parts of the surface which parts have been extracted in relation to two or more of the plurality of emitting means.

With the above configuration, it is possible to specify, on the basis of the regions extracted in relation to the respective emitting means, (a) a part having a high reliability of actual occurrence of an abnormal change in surface profile or (b) a region including the part.

(Supplementary Note 2)

The device described in Supplementary Note 1, wherein the device generates, on the basis of the reflection signal, a data set which includes plural pieces of data indicating positions on the surface and which allows for identification of a corresponding one of the plurality of emitting means; and the device extracts, with use of the generated data set, the part of the surface which part has the abnormal change, the extracting being carried out for each of the plurality of the emitting means.

With the above configuration, it is possible to specify, with high accuracy, the region having an abnormal change.

(Supplementary Note 3)

The device described in Supplementary Note 1 or 2, wherein the device determines, for each of a plurality of regions included in the surface, the number of emitting means in relation to which the part has been extracted; and specify, among the plurality of regions, a region for which the determined number satisfies a criterion for determination of presence or absence of an abnormal change.

With the above configuration, it is possible to specify the region having an abnormal change with high robustness against a variation in measurement carried out by the distance measuring device.

(Supplementary Note 4)

The device described in any one of Supplementary Note 1 to 3, wherein the device extracts the part by referring to an amount of change in depth to the surface of the subject.

With the above configuration, it is possible to specify (a) depth data considered to have a high reliability as surface profile data or (b) a region including the depth data.

(Supplementary Note 5)

The device described in Supplementary Note 2, wherein the device specifies the part by referring to a distance between (a) the position on the surface estimated on a basis of the plurality of data sets and (b) the part.

With the above configuration, it is possible to specify, as a changed part, a position where the profile differs from its surroundings.

(Supplementary Note 6)

The device described in Supplementary Note 2 or 5, wherein in a case where the device specifies the region, the device specifies the region by referring to the number of the parts each associated with, among the plurality of emitting means, another emitting means located within a given range from the part.

With the above configuration, it is possible to specify a region including a plurality of changed parts.

(Supplementary Note 7)

The device described in Supplementary Note 6, wherein the given range is set on the basis of at least any one selected from the group consisting of a distance measurement error, a magnitude of a noise, and an error occurring in transforming the plurality of data sets into common coordinates.

With the above configuration, it is possible to eliminate a changed part which is based on any of these errors.

(Supplementary Note 8)

The device described in any one of Supplementary Note 1 to 7, wherein the device derives a reliability of the part on a basis of the number of changed parts associated with the plurality of emitting means located within the given range.

With the above configuration, it is possible to specify, among the changed parts, a changed part having a higher reliability.

(Supplementary Note 9)

The device described in Supplementary Note 8, wherein the device derives a reliability of the part by referring to a weight of the data set of a corresponding one of the plurality of emitting means which weight has been set on a basis of the number of parts associated with the corresponding one of the plurality of emitting means.

With the above configuration, it is possible to determine a degree of the possibility (reliability) that the part actually has deformation.

(Supplementary Note 10)

The device described in any one of Supplementary Note 1 to 9, wherein the device extracts the part by referring to an amount of change in depth along a direction intersecting a traveling direction of the distance measuring device.

With the above configuration, it is possible to specify the part along a direction in which the distance measuring device carries out laser scanning.

(Supplementary Note 11)

The device described in any one of Supplementary Note 1 to 9, wherein the device extracts the part by referring to a distance between (a) the position on the surface obtained along the traveling direction of the distance measuring device and (b) the part.

With the above configuration, it is possible to specify the part along the traveling direction of the distance measuring device.

(Supplementary Note 12)

A method including: at least one processor extracting, on a basis of a reflection signal generated in response to a signal that one of a plurality of emitting means included in a distance measuring device has emitted to a subject, a part of a surface of the subject which part has an abnormal change, the extracting being carried out for each of the plurality of the emitting means; and the at least one processor specifying a region of the surface, the region including parts of the surface which parts have been extracted in relation to two or more of the plurality of emitting means.

With the above configuration, it is possible to provide the same effect as that of Supplementary Note 1.

(Supplementary Note 13)

A program causing a computer to execute: a process of extracting, on a basis of a reflection signal generated in response to a signal that one of a plurality of emitting means included in a distance measuring device has emitted to a subject, a part of a surface of the subject which part has an abnormal change, the extracting being carried out for each of the plurality of the emitting means; and a process of specifying a region of the surface, the region including parts of the surface which parts have been extracted in relation to two or more of the plurality of emitting means.

(Supplementary Note 14)

A non-transitory, computer-readable storage medium in which the program described in Supplementary Note 13 is stored.

(Supplementary Note 15)

An abnormal position detecting system including: a plurality of emitting means each of which emits a signal; receiving means each of which receives a reflection signal generated in response to the signal emitted by one of the plurality of extracting means; an extracting means which extracts, on a basis of the reflection signal, a changed part in which a surface profile of a structure changes, the extracting being carried out for each of the plurality of emitting means; and a specifying means which specifies, on a basis of data sets in relation to the different extracting means, (a) a plurality of changed parts arranged relatively densely or (b) a region including the plurality of changed parts.

With the above configuration, it is possible to provide the same effect as that of Supplementary Note 1.

(Supplementary Note 16)

The abnormal position detecting system described in Supplementary Note 15, further including: an operation control means which controls a device capable of executing certain operation with respect to (a) the plurality of changed parts arranged relatively densely or (b) the region including the plurality of changed parts, the plurality of changed parts or the region having been specified by the specifying means.

(Supplementary Note 17)

An abnormal position detecting program causing a computer to operate as any one of the devices described in Supplementary Note 1 to 11, the program causing the computer to function as each means.

(Supplementary Note 18)

A device including at least one processor configured to execute: an extracting process of extracting, from each of the data sets indicating a position on a surface of a subject which data sets are obtained in relation to a plurality of emitting means included in a distance measuring device configured to emit signals, a changed part having a change in a profile of the surface; and a process of specifying, on a basis of the data sets obtained in relation to the respective different emitting means, (a) a plurality of changed parts arranged relatively densely or (b) a region including the plurality of changed parts.

Note that the device may further include a memory. In the memory, a program causing the processor to execute the extracting process and the specifying process may be stored. The program may can be stored in a non-transitory, tangible storage medium capable of being read by a computer.

(Supplementary Note 19)

A device including: a signal section including a plurality of channels each including an emitting section and a receiving section, the emitting section being configured to emit a signal to a subject, the receiving section being configured to receive a reflection signal generated in response to the signal; and a specifying section configured to specify, on a basis of the reflection signal, a part of a surface of the subject which part has an abnormal change, for each of the plurality of channels, and to specify a region including parts specified in relation to two or more of the plurality of channels.

With the above configuration, it is possible to specify, on the basis of the regions extracted in relation to the respective channels, (a) a part having a high reliability of actual occurrence of an abnormal change in surface profile or (b) a region including the part.

### REFERENCE SIGNS LIST

1, 1A: abnormal position detecting device
2, 2A, 2B, 2C: abnormal position detecting system
10: control section
11: extracting section
12: specifying section
13: reliability deriving section
15: output section
16: memory
17: input-output IF
18: operation control section
20: database
25: display section
30: tunnel
32: mobile vehicle
35, 36, 37: scanning range
40: distance measuring device
41: emitting section
42: receiving section

1. A device comprising at least one processor configured to:
extract, on a basis of a reflection signal generated in response to a signal that one of a plurality of emitting sections included in a distance measuring device has emitted to a subject, a part of a surface of the subject which part has an abnormal change, the extracting being carried out for each of the plurality of the emitting sections; and
specify a region of the surface, the region including parts of the surface which parts have been extracted in relation to two or more of the plurality of emitting sections.

2. The device according to claim 1, wherein
the at least one processor is further configured to:
generate, on the basis of the reflection signal, a data set which includes plural pieces of data indicating a position on the surface and which allows for identification of a corresponding one of the plurality of emitting sections; and
extract, with use of the generated data set, the part of the surface which part has the abnormal change, the extracting being carried out for each of the plurality of the emitting sections.

3. The device according to claim 1, wherein
the at least one processor is further configured to:
determine, for each of a plurality of regions included in the surface, the number of emitting sections in relation to which the part has been extracted; and
specify, among the plurality of regions, a region for which the determined number satisfies a criterion used to determine presence or absence of an abnormal change.

4. The device according to claim 1, wherein
the at least one processor is further configured to:
extract the part by referring to an amount of change in depth to the surface of the subject.

5. The device according to claim 2, wherein
the at least one processor is further configured to:
specify, in a case where the device specifies the region, the region by referring to the number of the parts each associated with, among the plurality of emitting sections, another emitting section located within a given range from the part.

6. The device according to claim 5, wherein
the at least one processor is further configured to:
derive a reliability of the part by referring to a weight of the data set of a corresponding one of the plurality of emitting sections which weight has been set on a basis of the number of parts associated with the corresponding one of the plurality of emitting sections.

7. The device according to claim 1, wherein
the at least one processor is further configured to:
extract the part by referring to an amount of change in depth along a direction intersecting a traveling direction of the distance measuring device.

8. The device according to claim 1, wherein
the at least one processor is further configured to:
extract the part by referring to a distance between (a) a position on the surface obtained along a traveling direction of the distance measuring device and (b) the part.

9. A method comprising:
at least one processor extracting, on a basis of a reflection signal generated in response to a signal that one of a plurality of emitting sections included in a distance measuring device has emitted to a subject, a part of a surface of the subject which part has an abnormal change, the extracting being carried out for each of the plurality of the emitting sections; and
the at least one processor specifying a region of the surface, the region including parts of the surface which parts have been extracted in relation to two or more of the plurality of emitting sections.

10. A non-transitory, computer-readable storage medium in which a program is stored, the program causing a computer to execute:
a process of extracting, on a basis of a reflection signal generated in response to a signal that one of a plurality of emitting sections included in a distance measuring device has emitted to a subject, a part of a surface of the subject which part has an abnormal change, the extracting being carried out for each of the plurality of the emitting sections; and
a process of specifying a region of the surface, the region including parts of the surface which parts have been extracted in relation to two or more of the plurality of emitting sections.
